(19) United States
(12) Patent Application Publication
(10) Pub. No.: US 2015/0058228 A1
(43) Pub. Date: Feb. 26, 2015

(54) ROLE-BASED SYSTEMS AND COMPUTER PROGRAMS FOR MANAGING COMPLEX PROJECTS

(71) Applicant: Black & Veatch Holding Company, Kansas City, MO (US)

(72) Inventor: John George Voeller, Leawood, KS (US)

(21) Appl. No.: 14/528,965

(22) Filed: Oct. 30, 2014

Related U.S. Application Data
(63) Continuation-in-part of application No. 13/867,801, filed on Apr. 22, 2013.

(51) Int. Cl. G06Q 10/10; G06Q 50/00

(52) U.S. Cl. CPC G06Q 10/103; G06Q 50/01
USPC 705/301

(57) ABSTRACT

A system for managing complex projects with a plurality of participants and entities including people and objects comprises a server device with a processing element and associated memory element. The processing element executes a server application which includes a common database interface, a common object model, a plurality of profiles, and a role-based intelligent object model. The common database interface receives first data from software applications of each participant. The common object model includes a plurality of base terms, wherein each base term is associated with at least one property corresponding to at least one participant. There is one profile for each entity involved in the project, wherein the profile defines at least one relationship with at least one other entity and includes second data related to the project. The role-based intelligent object model sends a message to other entities when the second data for one entity changes.

### RELATED APPLICATION

This is a continuation-in-part of U.S. application Ser. No. 13/867,801, filed Apr. 22, 2013, entitled ROLE-BASED SYSTEMS AND COMPUTER PROGRAMS FOR MANAGING COMPLEX PROJECTS, which is hereby incorporated by reference into the present application in its entirety.

### BACKGROUND OF THE INVENTION

1. Field of the Invention

Embodiments of the current invention relate to systems including software applications for managing complex projects.

2. Description of the Related Art

Large and/or complex projects such as highway, bridge, or dam construction projects; home or building construction projects; and ship or aircraft construction projects typically include a plurality of participants, such as owners, managers, contractors, subcontractors, vendors, suppliers, and the like. Management of such large-scale projects requires the various participants to exchange data regarding components or parts used in the project and is often ineffective because the participants often have part or reference numbers and naming conventions that are different from one another. Tracking of parts or components is therefore difficult to manage. In addition, delays or changes in due dates are often not communicated between the participants. Project management software has been developed to assist with the management of large-scale projects, but participants are often reluctant to use such software because it completely replaces systems to which they are accustomed, leading to improper and incomplete tracking of the progress of projects.

### SUMMARY OF THE INVENTION

Embodiments of the current invention solve the above-mentioned problems and provide a distinct advance in the art of systems and computer programs for managing complex projects. Specifically, embodiments of the current invention provide systems and computer programs that manage a plurality of profiles for both people and objects and alert the appropriate entities when data in the profiles change.

A first embodiment of the current invention provides a system for managing complex projects with a plurality of participants and entities including people and objects. The system comprises a server device with a processing element and associated memory element. The processing element executes a server application which includes a common database interface, a common object model, a plurality of profiles, and a role-based intelligent object model. The common database interface receives first data from software applications of each participant. The common object model includes a plurality of base terms, wherein each base term is associated with at least one property corresponding to at least one participant. There is one profile for each entity involved in the project, wherein the profile defines at least one relationship with at least one other entity and includes second data related to the project. The role-based intelligent object model sends a message to other entities when the second data for one entity changes.

A second embodiment of the current invention provides a non-transitory computer-readable storage medium with an executable program stored thereon for managing complex projects with a plurality of participants and entities including people and objects. The program instructs a processing element to perform the following steps: receiving first data from a plurality of agents that monitor the software applications of each participant; maintaining a plurality of base terms, each base term associated with at least one property corresponding to at least one participant; maintaining a plurality of profiles, one profile for each entity involved in the project, the profile defining at least one relationship with at least one other entity and including second data related to the project; and sending a message to other entities when the second data for one entity changes.

A third embodiment of the current invention provides a method for managing complex projects with a plurality of participants and entities including people and objects. The method comprises the steps of: receiving first data from a plurality of agents that monitor the software applications of each participant; maintaining a plurality of base terms, each base term associated with at least one property corresponding to at least one participant; maintaining a plurality of profiles, one profile for each entity involved in the project, the profile defining at least one relationship with at least one other entity and including second data related to the project; and sending a message to other entities when the second data for one entity changes.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a system for managing complex projects with a plurality of participants, constructed in accordance with various embodiments of the current invention;

FIG. 2 is a schematic block diagram of the components of a server device;

FIG. 3 is a schematic block diagram of the components of a server application;

FIG. 4 is a block diagram depicting a plurality of participant devices;

FIG. 5 is a schematic block diagram of the components of a participant device;

FIG. 6 is a flow diagram of at least a portion of the steps of a method for managing complex projects with a plurality of participants;

FIG. 7 is a flow diagram of at least a portion of the steps of an embodiment of the method for managing complex projects; and

FIG. 8 is a flow diagram of at least a portion of the steps of another embodiment of the method for managing complex projects.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

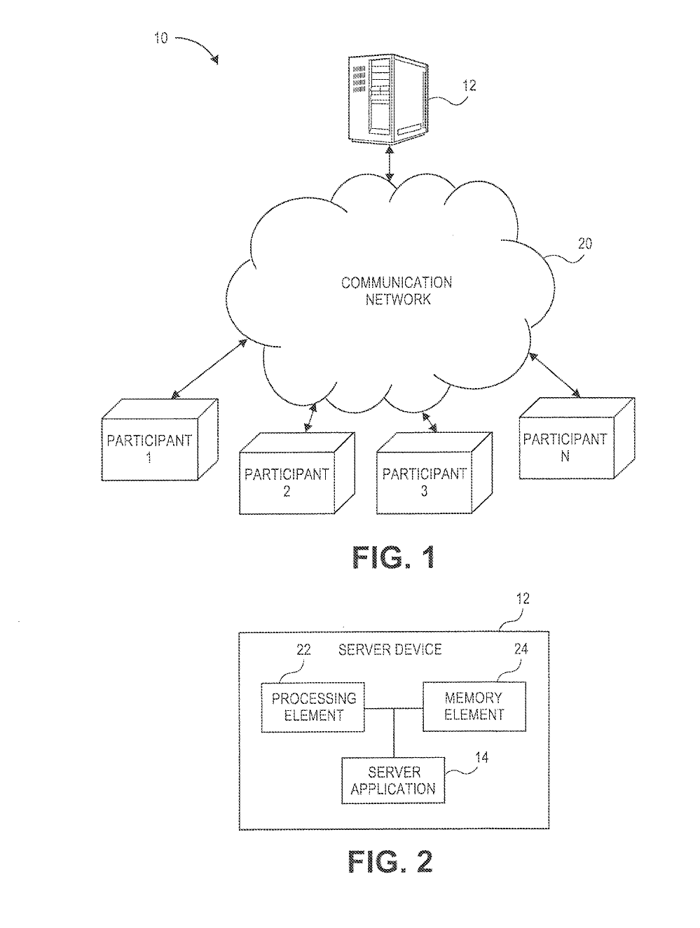

A system 10 for managing complex projects, constructed in accordance with various embodiments of the current invention, is shown in FIG. 1. The projects generally include large-scale endeavors such as engineering projects including highway, bridge, dam, or utility construction projects; architectural projects including building construction projects; or manufacturing projects including ship or aircraft construction projects. The projects typically include a plurality of participants, such as owners, managers, contractors, subcontractors, vendors, suppliers, and the like. The system 10 may broadly comprise a server device 12 and a server application 14. Various embodiments of the current invention may be implemented in hardware, software, firmware, or combinations thereof. Furthermore, the system 10 may communicate with a plurality of participant devices 16 each executing a plurality of participant applications 18. Communication with the participant devices 16 may occur through a communication network 20.

The server device 12 generally stores electronic data and may include application servers, database servers, file servers, mail servers, print servers, web servers, or the like, or combinations thereof. The server device 12 may be implemented in a dedicated network or an open network like the World Wide Web or a cloud network. Furthermore, the server device 12 may include a plurality of physical servers, virtual servers, or combinations thereof. In some embodiments, the server device 12 may be physically separated or isolated from the participant devices 16. In other embodiments, the server device 12 may be included with, retained by, or executed on one or more of the participant devices 16. The server device 12 may be configured to include or execute software such as database applications, web server applications, file server applications, mail server applications, or the like.

The server device 12 may include a processing element 22 and a memory element 24, as shown in FIG. 2. The processing element 22 may include microprocessors, microcontrollers, digital signal processors (DSPs), field-programmable gate arrays (FPGAs), analog and/or digital application-specific integrated circuits (ASICs), and the like, or combinations thereof. The processing element 22 may generally execute, process, or run instructions, code, software, firmware, programs, applications, apps, services, daemons, or the like, or may step through states of a finite-state machine.

The memory element 24 may include data storage components such as read-only memory (ROM), programmable ROM, erasable programmable ROM, random-access memory (RAM), hard disks, floppy disks, optical disks, flash memory, thumb drives, universal serial bus (USB) drives, and the like, or combinations thereof. The memory element 24 may include, or may constitute, a “computer-readable medium”. The memory element 24 may store the instructions, code, software, firmware, programs, applications, apps, services, daemons, or the like that are executed by the processing element 22. The memory element 24 may also store settings, data, documents, sound files, photographs, movies, images, databases, and the like. The processing element 22 may be in communication with the memory element 24 through address busses, data busses, control lines, and the like.

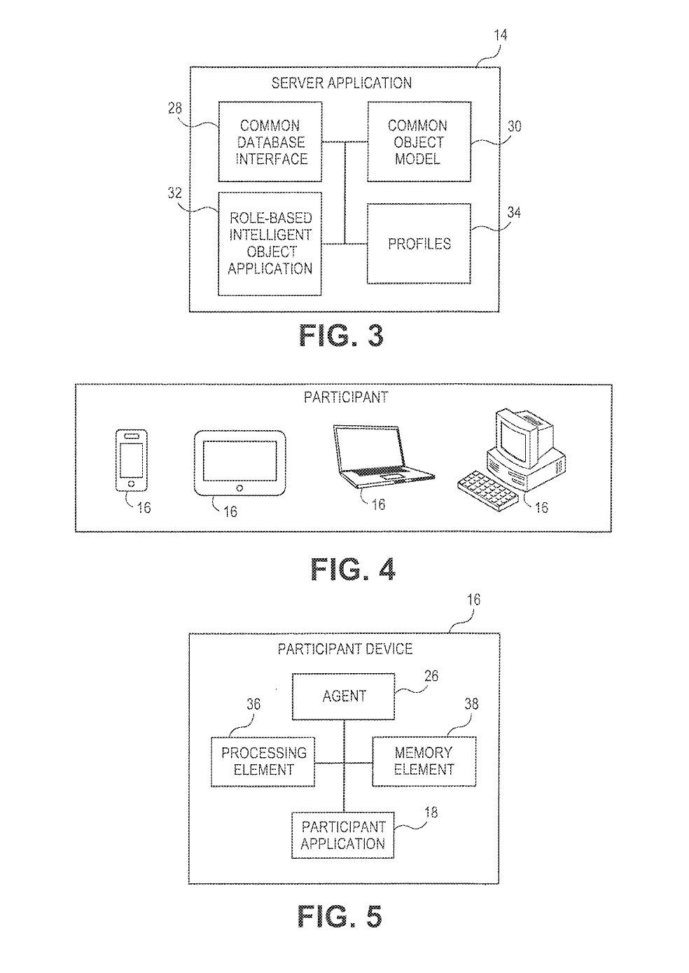

The server application 14 generally maintains the data related to the system 10 and may issue alerts or notices based on changes to the data related to the project. The server application 14 may be formed from instructions, code, software, firmware, programs, applications, apps, processes, services, daemons, or the like. The server application 14 may include a plurality of agents 26, a common database interface 28, a common object model 30, and a role-based intelligent object application 32, as shown in FIG. 3. In various embodiments, at least a portion of the server application 14 may be implemented as a web site or web application which provides access to or viewing of the data related to the project. Furthermore, the server application 14 may include data communications applications such as social networking, electronic mail, messaging such as the short message service (SMS), and the like.

The agents 26 generally monitor the activity of the participant applications 18 and report when project-related data is entered, updated, or changed. The agents 26 may include applications, apps, processes, services, daemons, or the like that are installed on and run on the participant devices 16, as seen in FIG. 5. The agents 26 may access or be embedded in the participant applications 18. Alternatively, or in addition, the agents 26 may monitor data that is written to one or more files or sent to one or more servers. The agents 26 are generally not visible to the users of the participant applications 18 and operate transparently. When data is entered, updated, or changed that is relevant to the project, the agents 26 send the data, optionally with an alert, through the common database interface 28 and the common object model 30 to the role-based intelligent object application 32.

The common database interface 28 generally communicates with the participant applications 18 of the various participants of the project and may include an implementation of the Apache Hadoop database or the like that has been customized to receive data from and transmit data to the types of participant applications 18 for a given project.

The common object model 30 generally serves as a translation or lookup table for entities such as physical objects, personnel, and data that vary from participant to participant in the project. The common object model 30 may include a base or generic term for a physical object, a person, or data as a tabular or relational entry along with a field or column that includes a value or property for each participant. For example, a first participant may refer to wall components as drywall while a second participant may refer to wall components as plaster board. The common object model 30 may include an entry for “wall component” with fields or columns that include the equivalent names used by each participant. Or, a first participant may have a first part number for a commonly used electric transformer while a second participant may use a second part number, different from the first part number. The common object model 30 may include an entry for the transformer with fields or columns that include the part number used by each participant.

The role-based intelligent object application 32 generally manages the interactions between people and physical objects involved in the project based on the roles and data of each one. The role-based intelligent object application 32 may establish, maintain, or have access to a profile 34 for each entity, such as a physical object or a person, which is part of the common object model 30 which includes one or more data items as well as one or more relationships for each physical object and person. The profiles 34 may form or be a part of a central database. The data and relationships may define various roles that determine when and between whom messages, such as notices and alerts, are sent concerning activities and events of the project.

The data may include attributes or identifying characteristics such as a name, a description, one or more groups or systems to which the person or object belongs, levels of hierarchy, a location, one or more dates for which relevant events will occur, a mode of implementation, and the like. Some people or objects possess certain attributes while other people and objects possess different attributes. Furthermore, the types of attributes and their values may change over time or as other events occur.

The relationships may be defined between two or more people, one or more persons and one or more objects, or two or more objects. The relationships may utilize concepts found in social networking programming or the like and may include: “like”, “own”, “has”, “need”, “share”, “connect”, “delay”, “cannot”, “observe”, “connect”, and so forth. Each concept is discussed below.

“Like” indicates a person or object is interested in everything another person or object does or has done to it, its current status, what it provides, and what else is associated with it.

“Own” indicates ownership of a particular object or asset.

“Has” indicates current possession of a particular object or asset.

“Need” indicates a person or object has need of another person or object.

“Share” indicates a person or object shares possession of an object.

“Connect” indicates a person or object wishes to connect with another person or object.

“Delay” indicates a person or object will or needs to delay a task, a schedule, or a milestone.

“Cannot” indicates a person or object cannot or will not perform a task as expected.

“Observe” indicates a person or object reports an observation independent from its normal role.

“Flag” indicates a person or object raises a flag without regard to recipients or a group.

As an example, a person may have a profile 34 that includes a name or title and descriptive responsibilities. The profile 34 may also include ownership of certain objects or assets, current possession of certain objects or assets, one or more needs for certain objects or assets, and so forth. In addition, a person may “like” other people or objects. An object may have a profile 34 that includes a name, part numbers, and a functional description. Some objects may have additional data and relationships defined. For example, a piece of equipment, such as a pump, that is to be assembled for use with the project may have a date of assembly, a date of installation, and the like. The pump may also have a location that changes during various stages of assembly to final installation. In addition, various component parts may be used to assemble the pump, and accordingly the pump may “need” or “like” the parts. The pump may also “have” the parts once they are incorporated into the pump.

Based on the data and relationships of the profiles 34, the role-based intelligent object application 32 may determine the distribution of messages concerning a particular person or object. For example, any person or object who likes another person or object may receive messages concerning every aspect of the person or object of interest. Any person or object that owns an object may receive messages when the object changes possession or location. Any person or object that needs an object may receive messages only when the object changes location or if a date of delivery changes. The role-based intelligent object application 32 may change the relevant data in the profile 34, such as dates or locations, and may also send a message to any person that has an interest (“like”, “own”, “need”, etc.) in the object or person.

The participant devices 16 generally allow users to manage various aspects of the project. The users may include project managers, foremen, laborers, vendor or supplier representatives, information technology (IT) technicians or programmers, or the like. The participant devices 16 may also allow the users as well as physical objects to communicate with the server device 12. The physical objects may include building materials such as lumber, steel, sand, gravel, and the like, building components such as piping, conduit, beams, sheets of plywood or drywall, and the like, tools or pieces of equipment such as cranes, steam rollers, jackhammers, drills, and the like, as well as other objects used for construction.

The participant devices 16 may include electronic devices capable of executing an application and communicating through the communication network 20. Examples of the participant device 16, as shown in FIG. 4, include workstation computers, desktop computers, laptop computers, palmtop computers, notebook computers, tablets or tablet computers, smartphones, mobile phones, cellular phones, personal digital assistants (PDAs), and the like. The participant devices 16 may also include file servers, application servers, database servers, and the like. Typically, each participant device 16 includes a processing element 36 and a memory element 38, as seen in FIG. 5. The processing element 36 may be substantially the same as the processing element 22 in structure and function. The memory element 38 may be substantially the same as the memory element 24 in structure and function.

Each participant device 16 may also include a communication port that permits the participant device 16 to communicate with the server device 12, the communication network 20, or other participant devices 16. The communication may occur wirelessly and/or through wires. Wireless communication may utilize radio frequency (RF) communication including cellular or mobile phone standards such as 3G or 4G, Institute of Electrical and Electronics Engineers (IEEE) 802.11 standards for wireless networking, Bluetooth™ standards, and the like. Accordingly, the participant device 16 may include one or more broadband wireless transmitters and receivers. Wired communications may be implemented through metal conductor cables, wires, and connectors or optical fiber cables. Thus, each participant device 16 may include one or more transmitter and receiver circuits for use with cables.

Some participant devices 16, particularly those for use with physical objects, may further include or be in communication with a geolocation device that determines the geographical position of the device. The geolocation device may be or include a satellite navigation receiver that works with a global navigation satellite system (GNSS) such as the global positioning system (GPS) primarily used in the United States, the GLONASS system primarily used in the Soviet Union, or the Galileo system primarily used in Europe. The geolocation device may include an antenna to assist in receiving the satellite signals. The antenna may be a patch antenna, a linear antenna, or any other type of antenna that can be used with location or navigation devices. The geolocation device may further include one or more processors, controllers, or other computing elements and memory so that it may calculate location and other geographic information.

In some embodiments, the participant device 16, or at least the geolocation device, may be positioned on or in the physical object. In other embodiments, the participant device 16, or at least the geolocation device, may be embedded in a housing or package in which the physical object is transported. In yet other embodiments, the geolocation information for the physical object may be entered by a user such as an employee of a shipping company.

In addition to geolocation devices, the participant device 16 may also include or be in communication with other sensors, such as thermometers, hygrometers, transducers, and the like, that measure relevant environmental data, perhaps for a physical object. For example, a part for a piece of equipment or a component of the project may require to be maintained within a certain temperature range. The temperature of the part or component may be measured, recorded, and tracked during the project. The data from the sensor may be forwarded to the participant device 16 which stores it or processes it with one or more participant applications 18.

The participant applications 18 generally allow users or physical objects to enter, update, or change information regarding the project. The participant applications 18 may also allow users to receive alerts or notices regarding information stored on the server device 12. The participant applications 18 may include software, programs, applications, or apps such as database management software, spreadsheet software, text editing software, and so forth that are operable to manipulate relational data, hierarchical data, linked data, tabular data, text data, and the like. The participant applications 18 may further include applications or programs that are operable to handle data communications such as social networking, electronic mail, messaging such as the short message service (SMS), and the like, as well as web browsers, web viewers, or Internet browsers that are operable to access web sites. Some embodiments participant applications 18 may also be able to handle geolocation or sensor data that is received from geolocation devices or sensors.

The communication network 20 generally allows communication between the participant devices 16 and the server device 12 as well as communication from one participant device 16 to another. The communication network 20 may include local area networks, metro area networks, wide area networks, cloud networks, the Internet, or the like, or combinations thereof. The communication network 20 may also include or connect to voice and data communication systems such as cellular networks and public ordinary telephone systems. The communication network 20 may be wired, wireless, or combinations thereof and may include components such as switches, routers, hubs, access points, and the like. The participant devices 16 may connect to the communication network 20 either through wires, such as electrical cables or fiber optic cables, or wirelessly through known RF standards as discussed above.

The system 10 may operate as follows. At the beginning of a project, all of the participants in the project are identified along with their participant devices 16 and participant applications 18. The agents 26 may be installed on the participant devices 16 including handheld devices, desktop devices, servers, etc. The common database interface 28 may be prepared to communicate with the participant applications 18. Furthermore, each participant may identify the physical objects and people that will be involved in the project. Each participant may also provide a description and/or definition of the objects and people that includes names, proprietary terminology, part numbers, and other identifying data. This information may be used to establish at least a portion of the common object model 30. In addition, the terms of the project are established with the roles of the participants determined, the dates of milestones identified, and the goals of the project defined. This information may be used to set up the data and relationships that are monitored and managed by the role-based intelligent object application 32.

While the project is ongoing, the participants may note progress as milestones and deadlines are met and various phases of the project are completed. In addition, the participants may note delays, substitution of parts, changes to the specification or scope of the project, and so forth. The participants may use the participant applications 18 to track the events of the project. The agents 26 of the system 10 may monitor the activity of the participant applications 18 and may forward the entry or changing of any project-related data to the common database interface 28 which hands the data off to the common object model 30. Changes or updates may be made to the common object model 30 if relevant data, such as part numbers or terminology, changes. The role-based intelligent object application 32 may analyze the new data or changed data, may update any data, attribute, or relationship that depends on the changed data, and may alert any person or object that is affected by the change. For example, any person or object that likes, owns, has, needs, etc. the entity affected by the change may receive a message reporting the change. The role-based intelligent object application 32 may forward the message through the common object model 30 in order to convert the relevant portions of the message into terms that are specific to each recipient of the message. Then, the message may be transmitted to the recipients via communications tools such as email or text messaging.

Some data may be automatically updated in the system 10. For example, data may be sent from physical objects regarding their location or other information to the participant devices 16. The participant applications 18 may receive the data and update the appropriate databases, spreadsheets, or tracking software. Agents 26 monitoring the participant applications 18 may forward the data to the server application 14, which may update the data associated with or accessed by the role-based intelligent object application 32.

After the project is complete, the system 10 may automatically prepare or be prompted to prepare a report that summarizes or details the events and activities of the project. The report may be generated using the common object model 30 such that the report is prepared using the terms and data that are specific for a given recipient.

The system 10 allows large-scale complex projects with many participants to be managed. The system 10 provides the benefit of allowing each participant to use the software applications that he normally uses to work on a project, thereby avoiding the necessity of learning unfamiliar computer programs. In addition, each participant can continue using the language, terms, and reference numbers that he has always used. The system 10 monitors the activities of each participant and updates a central database when project-related events occur. Furthermore, the system 10 automatically alerts or notifies the relevant participants when events occur. Thus, the participants can track the progress of the project and respond to delays as necessary.

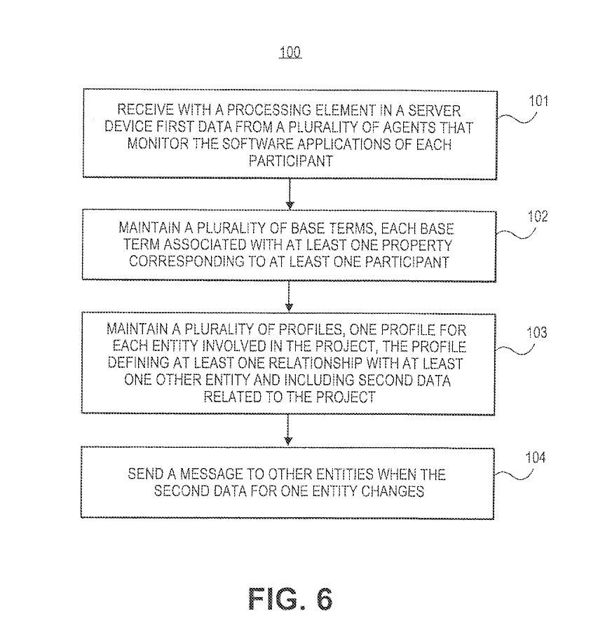

At least a portion of the steps of a method 100, in accordance with various embodiments of the current invention, for managing complex projects with a plurality of participants is shown in FIG. 6. The steps of the method 100 may be performed in the order as shown in FIG. 6, or they may be performed in a different order. Furthermore, some steps may be performed concurrently as opposed to sequentially. In addition, some steps may not be performed.

Referring to step 101, data from a plurality of agents 26 is received by a server device 12 that includes a processing element 22. The agents 26 monitor the activity of a plurality of participant applications 18 and report when project-related data is entered, updated, or changed. The agents may forward the data to a common database interface 28.

Referring to step 102, a plurality of base terms is maintained in a common object model 30. There may be a base term for a physical object, a person, or data as a tabular or relational entry along with a field or column that includes a value or property for each participant.

Referring to step 103, a plurality of profiles 34 is maintained, wherein there is one profile 34 for each entity, such as a physical object or a person, which is part of the common object model 30 which includes one or more data items as well as one or more relationships for each physical object and person. The data and relationships may define various roles that determine when and between whom messages, such as notices and alerts, are sent concerning activities and events of the project.

Referring to step 104, a message may be sent to other entities when data for one entity changes. A role-based intelligent object application 32 may change the relevant data in the profile 34, such as dates or locations, and may also send a message to any person that has an interest in the object or person.

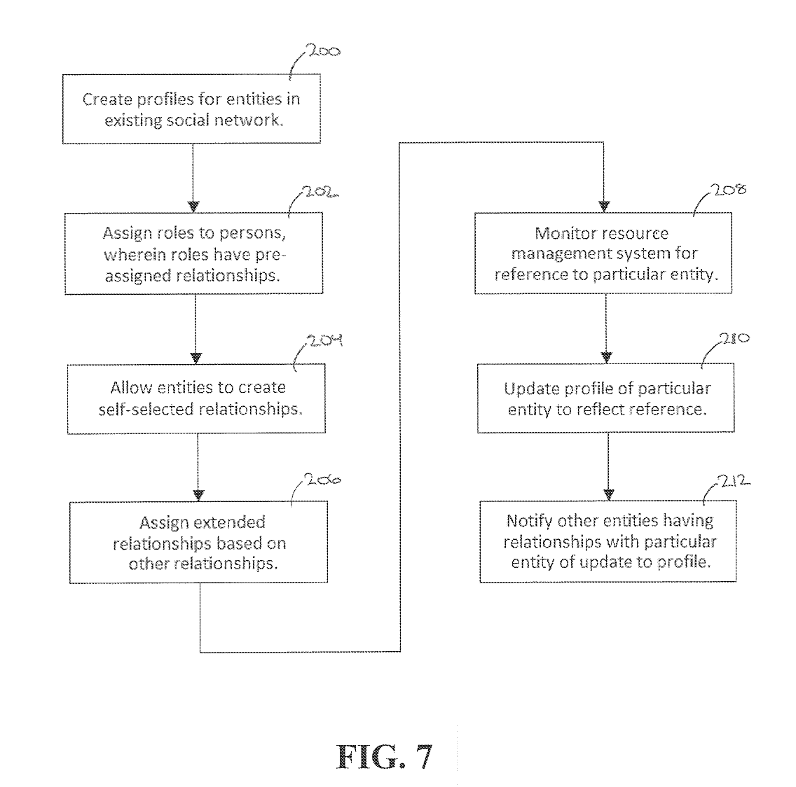

FIG. 7 illustrates steps in another embodiment of the method and/or computer program of the present invention for managing a complex process involving a plurality of entities from an organization having a computerized resource management system, wherein the plurality of entities includes roles and objects. The computerized resource management system may be a computerized enterprise resource planning system, or it may be a plurality of computer systems that manage the organization's resources. The complex process may be selected from the group consisting of engineering projects, architecture projects, design projects, building projects, manufacturing projects, and military projects. The plurality of entities may include owners, managers, contractors, subcontractors, vendors, and suppliers, and the entities that are objects may include physical objects such as parts, equipment, or materials or non-physical objects such as milestones, due dates, shipping manifests, performance metrics, or substantially anything else about which another entity may need or desire to be informed. A profile for each entity may be created in an existing social network service, as shown in step 200. Each role may be assigned to a person, as shown in step 202, wherein each role may have one or more pre-assigned first relationships with a first subset of the plurality of entities within the existing social network, and wherein the pre-assigned first relationships may be selected from a plurality of types of relationships recognized by the existing social network system.

Each entity may be allowed to create one or more self-selected second relationships within the existing social network with a second subset of the plurality of entities, as shown in step 204, wherein the self-selected second relationships may be selected from the plurality of types of relationships recognized by the existing social network system. One or more extended third relationships may be substantially automatically created within the existing social network with a third subset of the plurality of entities that have pre-assigned first, self-selected second, or extended third relationships with the first or second subsets of entities, as shown in step 206, wherein the extended third relationships may be selected from the plurality of types of relationships recognized by the existing social network system. The computerized resource management system may be monitored for a reference to any particular entity, as shown in step 208. This may include equating any different terms used within the computerized resource management system for the particular entity. The reference to the particular entity may be substantially automatically generated by a sensor or other device. The profile of the particular entity may be substantially automatically updated to reflect the reference, as shown in step 210. All entities having pre-assigned first, self-selected second, or extended third relationships with the particular entity may be substantially automatically notified via the existing social network of the update to the profile of the particular entity, as shown in step 212. Stated another way, a first entity that has a relationship with a second entity may be substantially automatically notified of any change to the profile of the second entity or to the profiles of any other entities related to the second entity. A record may be substantially automatically maintained of all such references to the entities during the complex process.

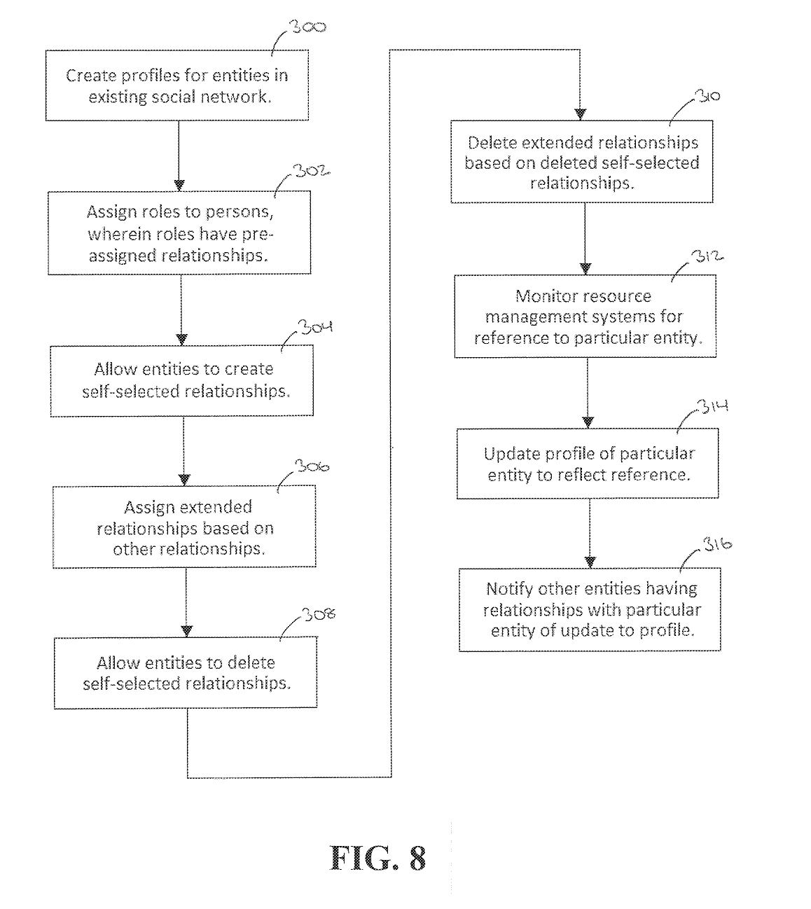

FIG. 8 illustrates steps in another embodiment of the method and/or computer program of the present invention for managing a complex enterprise involving a plurality of entities from a first participating organization having a first computerized enterprise resource planning system and from a second participating organization having a second computerized enterprise resource planning system, wherein the plurality of entities includes roles and objects. A profile may be created for each entity in an existing social network service, as shown in step 300. Each role may be assigned to a person, as shown in step 302, wherein each role may have one or more pre-assigned first relationships with a first subset of the plurality of entities within the existing social network, and wherein the pre-assigned first relationships may be selected from a plurality of types of relationships recognized by the existing social network system. Each entity may be allowed to create one or more self-selected second relationships within the existing social network with a second subset of the plurality of entities, as shown in step 304, wherein the self-selected second relationships may be selected from the plurality of types of relationships recognized by the existing social network system.

One or more extended third relationships may be substantially automatically created for each entity within the existing social network with a third subset of the plurality of entities that have pre-assigned first, self-selected second, or extended third relationships with the first or second subsets of entities, as shown in step 306, wherein the extended third relationships may be selected from the plurality of types of relationships recognized by the existing social network system. Each entity may be allowed to delete one or more of the self-selected second relationships within the existing social network with the second subset of the plurality of entities, as shown in step 308. One or more of the extended third relationships may be substantially automatically deleted based on the one or more of the self-selected second relationships that were deleted, as shown in step 310. The first and second computerized enterprise resource planning systems may be substantially automatically monitored for a reference to any particular entity, including equating any different terms used by the first and second computerized enterprise resource planning systems for the particular entity, as shown in step 312. The profile of the particular entity may be substantially automatically updated to reflect the reference, as shown in step 314. All entities having pre-assigned first, self-selected second, or extended third relationships with the particular entity may be substantially automatically notified via the existing social network of the update to the profile of the particular entity, as shown in step 316.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable medium having a computer program stored thereon for directing operation of a computing device to perform the following steps in managing a complex process involving a plurality of entities from an organization having a computerized resource management system, wherein the plurality of entities includes roles and objects:
(1) facilitating the creation of a profile for each entity in an existing social network service;
(2) facilitating the assignment of each role to a person, wherein each role has one or more pre-assigned first relationships with a first subset of the plurality of entities within the existing social network, wherein the pre-assigned first relationships are selected from a plurality of types of relationships recognized by the existing social network system;
(3) allowing each entity to create one or more self-selected second relationships within the existing social network with a second subset of the plurality of entities, wherein the self-selected second relationships are selected from the plurality of types of relationships recognized by the existing social network system;
(4) creating for each entity one or more extended third relationships within the existing social network with a third subset of the plurality of entities that have pre-assigned first, self-selected second, or extended third relationships with the first or second subsets of entities, wherein the extended third relationships are selected from the plurality of types of relationships recognized by the existing social network system;
(5) monitoring the computerized resource management system for a reference to a particular entity;
(6) updating the profile of the particular entity to reflect the reference; and
(7) notifying via the existing social network system all entities having pre-assigned first, self-selected second, or extended third relationships with the particular entity of the update to the profile of the particular entity.

2. The non-transitory computer-readable medium as set forth in claim 1, wherein the computerized resource management system is a computerized enterprise resource planning system.

3. The non-transitory computer-readable medium as set forth in claim 1, wherein the complex process is selected from the group consisting of: engineering projects, architecture projects, design projects, building projects, manufacturing projects, and military projects.

4. The non-transitory computer-readable medium as set forth in claim 1, wherein the plurality of entities include owners, managers, contractors, subcontractors, vendors, and suppliers.

5. The non-transitory computer-readable medium as set forth in claim 1, wherein the objects include parts, equipment, and materials.

6. The non-transitory computer-readable medium as set forth in claim 1, wherein the step (5) of monitoring the computerized resource management system for the reference to the particular entity includes equating any different terms used within the computerized resource management system for the particular entity.

7. The non-transitory computer-readable medium as set forth in claim 1, wherein in step (5) the reference to the particular entity is generated by a sensor.

8. The non-transitory computer-readable medium as set forth in claim 1, further including the step of maintaining a record of all the references to the particular entity during the complex process.

9. A non-transitory computer-readable medium having a computer program stored thereon for directing operation of a computing device to perform the following steps in managing a complex enterprise involving a plurality of entities from a first participating organization having a first computerized enterprise resource planning system and from a second participating organization having a second computerized enterprise resource planning system, wherein the plurality of entities includes roles and objects:
(1) facilitating the creation of a profile for each entity in an existing social network service;
(2) facilitating assigning each role to a person, wherein each role has one or more pre-assigned first relationships within the existing social network with a first subset of the plurality of entities, wherein the pre-assigned first relationships are selected from a plurality of types of relationships recognized by the existing social network system;
(3) allowing each entity to create one or more self-selected second relationships within the existing social network with a second subset of the plurality of entities, wherein the self-selected second relationships are selected from the plurality of types of relationships recognized by the existing social network system;
(4) creating for each entity one or more extended third relationships within the existing social network with a third subset of the plurality of entities that have pre-assigned first, self-selected second, or extended third relationships with the first or second subsets of entities, wherein the extended third relationships are selected from the plurality of types of relationships recognized by the existing social network system;
(5) monitoring the first and second computerized enterprise resource planning systems for a reference to a particular entity, including equating any different terms used by the first and second computerized enterprise resource planning systems for the particular entity;
(6) updating the profile of the particular entity to reflect the reference; and
(7) notifying via the existing social network system all entities having pre-assigned first, self-selected second, or extended third relationships with the particular entity of the update to the profile of the particular entity.

10. The non-transitory computer-readable medium as set forth in claim 9, wherein the complex process is selected from the group consisting of: engineering projects, architecture projects, design projects, building projects, manufacturing projects, and military projects.

11. The non-transitory computer-readable medium as set forth in claim 9, wherein the plurality of entities include owners, managers, contractors, subcontractors, vendors, and suppliers.

12. The non-transitory computer-readable medium as set forth in claim 9, wherein the objects include parts, equipment, and materials.

13. The non-transitory computer-readable medium as set forth in claim 9, wherein in step (5) the reference to the particular entity is generated by a sensor.

14. The non-transitory computer-readable medium as set forth in claim 9, further including the step of maintaining a record of all of the references to the particular entity during the complex process.

15. A non-transitory computer-readable medium having a computer program stored thereon for directing operation of a computing device to perform the following steps in managing a complex enterprise involving a plurality of entities from a first participating organization having a first computerized enterprise resource planning system and from a second participating organization having a second computerized enterprise resource planning system, wherein the plurality of entities includes roles and objects:
(1) facilitating the creation of a profile for each entity in an existing social network service;
(2) facilitating the assignment of each role to a person, wherein each role has one or more pre-assigned first relationships within the existing social network with a first subset of the plurality of entities, wherein the pre-assigned first relationships are selected from a plurality of types of relationships recognized by the existing social network system;
(3) allowing each entity to create one or more self-selected second relationships within the existing social network with a second subset of the plurality of entities, wherein the self-selected second relationships are selected from the plurality of types of relationships recognized by the existing social network system;
(4) creating for each entity one or more extended third relationships with a third subset of the plurality of entities that have pre-assigned first, self-selected second, or extended third relationships with the first or second subsets of entities, wherein the extended third relationships are selected from the plurality of types of relationships recognized by the existing social network system;
(5) allowing each entity to delete one or more of the self-selected second relationships within the existing social network with the second subset of the plurality of entities;
(6) deleting for each entity one or more of the extended third relationships created in step (4) based on the one or more of the self-selected second relationships deleted in step (5);
(7) monitoring the first and second computerized enterprise resource planning systems for any reference to a particular entity, including equating any different terms used by the first and second computerized enterprise resource planning systems for the particular entity;
(8) updating the profile of the particular entity to reflect the reference; and
(9) notifying via the existing social network system all of the entities having pre-assigned first, self-selected second, or extended third relationships with the particular entity of the update to the profile of the particular entity.

16. The non-transitory computer-readable medium as set forth in claim 15, wherein the complex process is selected from the group consisting of: engineering projects, architecture projects, design projects, building projects, manufacturing projects, and military projects.

17. The non-transitory computer-readable medium as set forth in claim 15, wherein the plurality of entities include owners, managers, contractors, subcontractors, vendors, and suppliers.

18. The non-transitory computer-readable medium as set forth in claim 15, wherein the objects include parts, equipment, and materials.

19. The non-transitory computer-readable medium as set forth in claim 15, wherein in step (7) the reference to the particular entity is generated by a sensor.

20. The non-transitory computer-readable medium as set forth in claim 15, further including the step of maintaining a record of all of the references to the particular entity during the complex process.
